(19) United States
(12) Patent Application Publication
(10) Pub. No.: US 2005/0171865 A1
(43) Pub. Date: Aug. 4, 2005

(54) Item display

(76) Inventor: Paul Rowland Beardow, Surrey (GB)

Correspondence Address: OPPENHEIMER WOLFF & DONNELLY LLP, 45 SOUTH SEVENTH STREET, SUITE 3300, MINNEAPOLIS, MN, 55402, US

(21) Appl. No.: 10/509,771

(22) PCT Filed: Mar. 26, 2003
(86) PCT No.: PCT/GB03/01340

(30) Foreign Application Priority Data
Mar. 28, 2002 (GB) 0207373.2

(51) Int. Cl. G06F 17/60

(52) U.S. Cl. 705/27

(57) ABSTRACT

A mobile telephone system (10, 12, 14, 18, 20) allows a mobile telephone (10, 20) to be used for viewing and selecting goods for sale. The mobile telephone (10) has a screen with a display area (28) comprising a control area (30) and control “buttons”, and a background zone (38) where images of items are sent from a server (18) to be displayed, in background profile, in display slots (40A, 40B, 40C), individual items being selected when at a selection point (50) to be displayed in a foreground zone (44) attended by a descriptive card (52). Foreground zone (44) views can be of a different view of a selected item (54) and can be from different perspectives and distances. Images can be provided to the mobile telephone (10) in the form of photographs, or as sets of image parts which can be assembled to make a complete image. The operating software of the mobile telephone (10) treats all types of images as equal entities. A monitor monitors the type of items or goods that are being viewed, finds the direction of alteration of the nature of items viewed, and adjusts the items in the next batch to be viewed to reflect the direction of thematic change.

The present invention relates to a method and apparatus for display of images of objects on a screen. It particularly relates to such display in mobile telephone equipment. It most particularly relates to selection and display of images of objects, by a viewer, where bandwidth or other network resources may be restricted.

Modern mobile telephones have been given a capacity, among other things, to receive and display images. Currently, a third generation of cell phones is being deployed where a handset is, effectively, connected whenever it is switched on. This permits for many more services, including the offer of goods or services for sale.

Increasing numbers of subscribers and an expectation of improved quality of image transmission has placed a particular burden on the bandwidth available for image transfer. Images are either poor, slow to appear, or both.

When items are presented for sale, it is most desirable that a “sale catalogue” image be of good quality. A poor quality image would not recommend the goods to a potential buyer. A slow to appear image would tend to lose the interest of the potential customer. Further, it is desirable that the potential customer be able to manipulate and inspect the goods in some detail. This increases the burden on the system.

The present invention seeks to provide a method and apparatus whereby high quality images may be made available at a receiving handset. Further, the present invention seeks to provide that a displayed item can be closely inspected and manipulated by a potential buyer. The present invention also seeks to provide a system where the purchasing interests of the customer can automatically be assessed and items presented to the potential customer which will be of interest.

According to a first aspect, the present invention consists in a method for displaying images of an object, said method including the steps of: sending one or more images of the object to a receiver; displaying a first image of the object on a screen, at said receiver, for possible selection, as a background perspective; advancing the first image of the object to a foreground perspective on said screen if the image is selected; and providing, in the receiver, at least one other selectably displayable image of a foreground perspective of the selected object.

According to a second aspect, the present invention consists in a system for displaying images of an object, said system comprising: a receiver; transmission means, operative to transmit one or more images of the object to said receiver; means, at said receiver, to display a first image of the object, as a background perspective, on a screen for possible selection; means to advance the first image of the object to a foreground perspective on said screen if the image is selected; and means to provide, in said receiver, at least one other selectably displayable image of a foreground perspective of the selected object.

According to a third aspect, the present invetion consists in reception means, operative to act as said receiver in such a system

According to a fourth aspect, the present invention consists in reception means, operative to act as said receiver when used in conjunction with such a method.

According to a fifth aspect, the present invention consists in transmission means, for use in transmitting images in such a system.

According to a sixth aspect, the present invention consists in transmission means, for use in sending images in conjunction with such a method.

The invention further provides that the step of sending of an image to a receiver includes the steps of sending the constructable parts of an image to a receiver and constructing the image.

The invention further provides that the constructable parts of an image include specifications for a wire frame representative of the shape of the object that the image is intended to represent and specifications for the provision on the wire frame of a textured skin representative of the appearance of the object the image is intended to represent.

The invention further provides that the specifications for a wire frame representative of the shape of the object that the image is intended to represent includes specification of the points of a starting mesh and means successively to divide the mesh to provide a frame having the shape of the object.

The invention further provides that the at least one other foreground view is achievable by viewing the constructed image from a selectable direction and/or distance.

The invention further provides that the step of sending an image to the receiver includes the provision of a representation of a photograph of the object.

The invention further provides that the step of providing, in the receiver, at least one other selectable foreground view, includes sending, to the receiver, at least one other representation of a photograph of the object, from a different viewpoint.

The invention further provides that the object is one of a plurality of objects, images of each of the plurality of objects being moveable across a background area until selected for foreground display.

The invention further provides that foreground display of the selected object can include increasing the size of the selected image and causing the selected image to obscure any image which it overlaps and which is still in the background.

The invention further provides that the receiver can comprise a fixed program of display which accepts, displays, moves and allows manipulation of images of objects as equivalent entities, irrespective of what that image might be.

The invention further provides for monitoring the nature of the goods selected for foreground display; detecting the direction in which classification of selected goods is moving away from the current preference; and providing, to the receiver, a next batch of images whose classification is moved, from the current preference, in the detected direction.

According to a second aspect, the invention consists in a receiver for use as described.

According to a third aspect, the invention consists in a transmitter, for use as described.

The invention further provides that the transmitter can be a mobile telephone system and the receiver can be a mobile telephone handset or Personal Digital Assistant.

The invention further provides that the transmitter can be an Internet transmission device and that the receiver can be a receiver of Internet images.

The invention further provides that the transmitter can be a digital transmission device and that the receiver can be a receiver of digitally conveyed images.

The invention is further explained, by way of example, by the following description, read in conjunction with the appended drawings, in which:

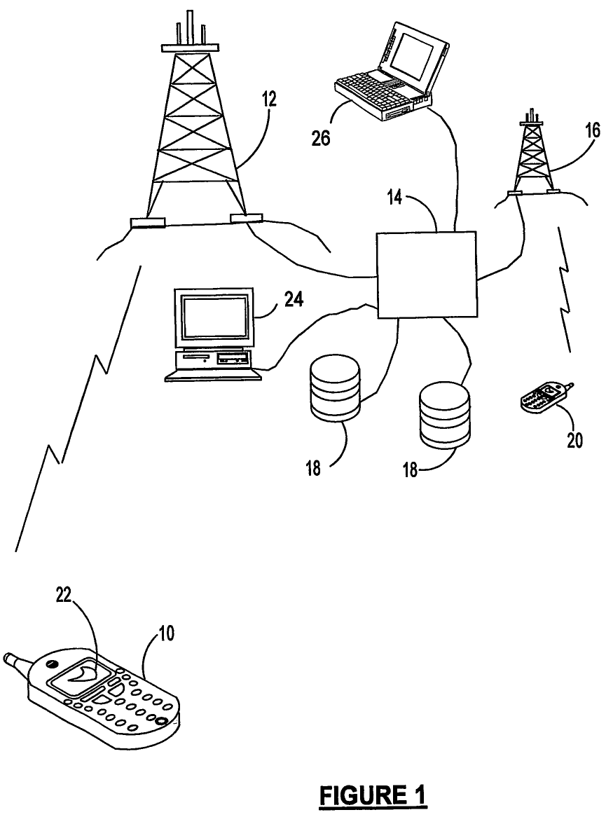

FIG. 1 is a Schematic diagram of the environment within which the preferred embodiment of the present invention is provided.

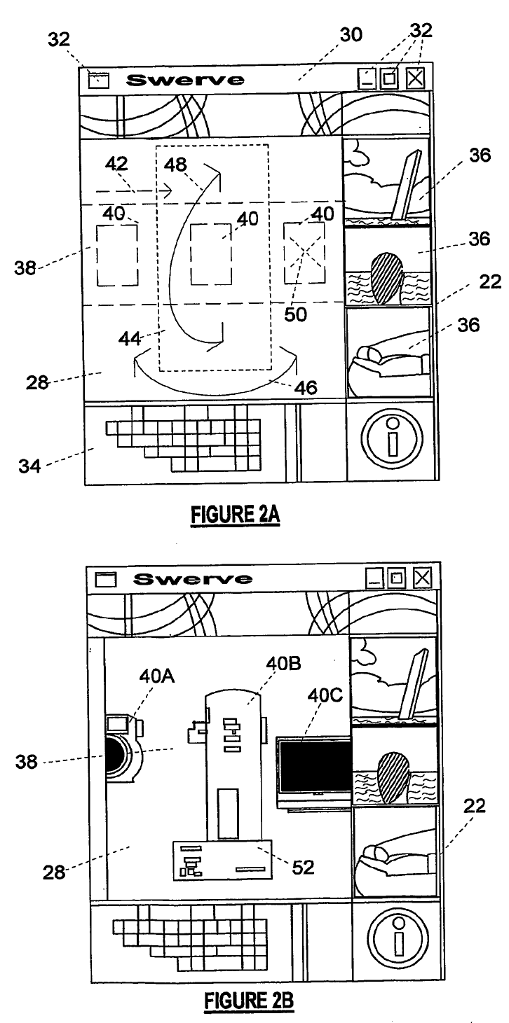

FIG. 2 shows a first exemplary screen on a mobile telephone.

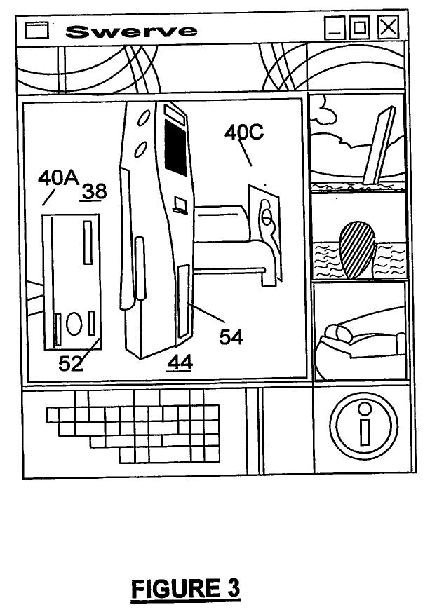

FIG. 3 shows a second exemplary screen on a mobile telephone.

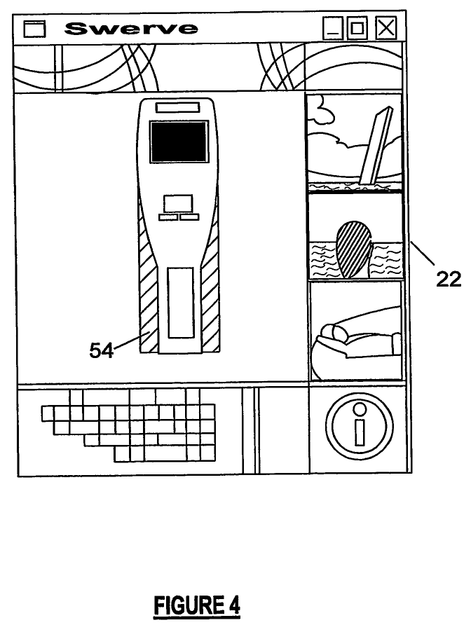

FIG. 4 shows a third exemplary screen on a mobile telephone.

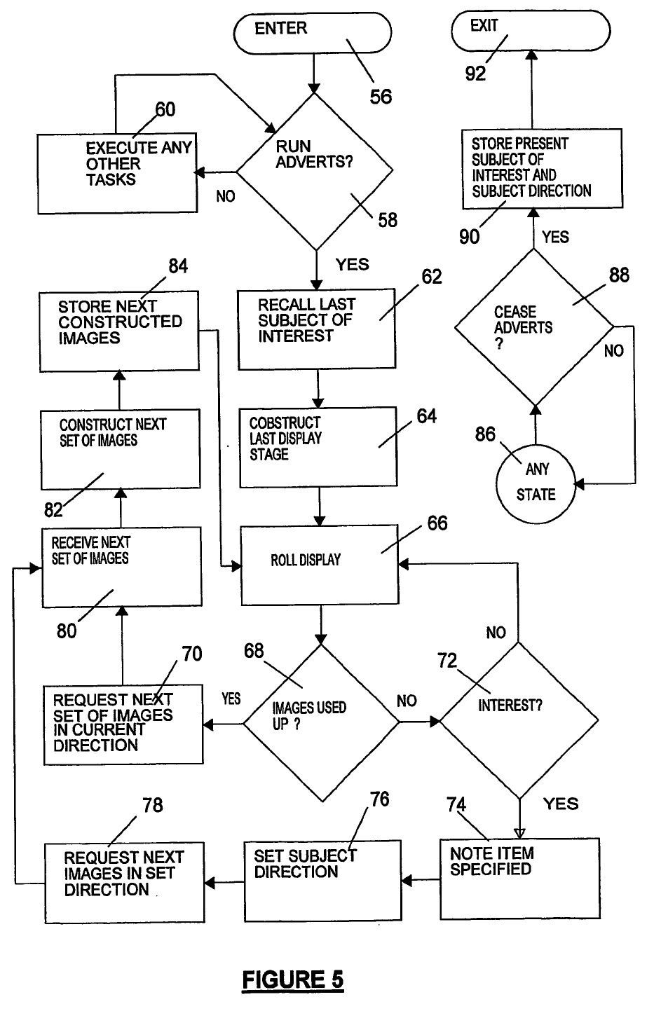

FIG. 5 is a flow chart showing the activity of a mobile telephone when displaying items according to the present invention.

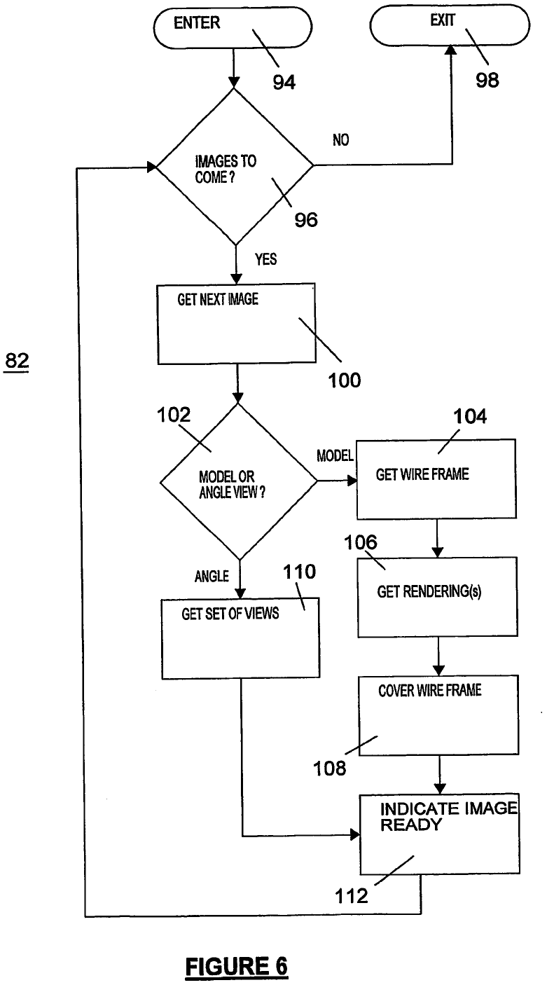

FIG. 6 is a flow chart illustrating how a mobile telephone may obtain images when employing the present invention.

And

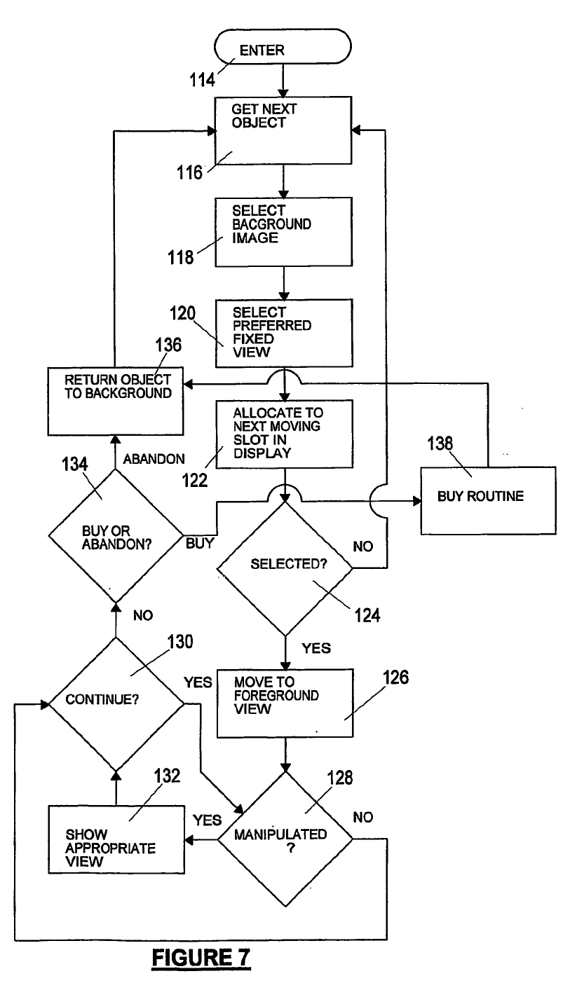

FIG. 7 is a flow chart illustrating how a mobile telephone can display objects when acting according to the present invention.

Attention is first drawn to FIG. 1, showing the environment within which the preferred embodiment of the invention is provided.

A mobile telephone 10 is part of a communications system. The mobile telephone 10 communicates with a base station 12 which, in turn, is connected by wires, cables, microwave link or satellite to the terrestrial telephone network 14 which provides communication via further base stations 16 and servers 18. The further base stations 16 permit communication with further mobile telephones 20. The mobile telephone 10 comprises a screen 22 whereon images can be displayed. The terrestrial telephone network 14 can, via the Internet or by direct file transfer, act as the conveyance for images to be displayed on fixed 24 or portable 26 computer equipment and on the screens 22 of mobile telephones 10, 20.

The present invention is concerned with the ability of a fixed resource such as a computer 26, 24 or a server 18 to send an image to the screen 22 of a mobile telephone 10, 20.

Although the invention is hereinafter described with reference to displaying images on the screen 22 of a mobile telephone 10, 20, it is to be understood that the present invention also applies to any environment where an image must be sent to and displayed on a screen 22 or a receiving apparatus where resources may be limited. Such situations include direct file transfer between computers, television, and the Internet. This list is not exclusive.

Attention is drawn to FIGS. 2A and 2B which show the screen 22 on the mobile telephone 10, 20 as it might be viewed according to the present invention.

FIG. 2A shows different areas of the screen 22. The screen 22 comprises a display area 28 where images of products are shown. Control areas 30 carry control buttons 32 which function in a manner well known in graphic user interfaces, well known to any user of a personal computer. Banner areas 34 can carry informative text and image material, or may simply support decoration or identification of the particular advertiser or provider driving the content of the screen 22. Index areas 36 allow the user to select what function the mobile telephone 10 will fulfil. By selecting a particular index area 36, the mobile telephone 10, 20 can be used for any of the purposes for which it is capable. For the purpose of the present invention, the mobile telephone 10, 20 is in a quiescent mode, where the user has not asked it to perform any particular task, and is displaying advertisements in the hope of catching the user's interest. Alternatively, the mobile telephone 10, 20 may have been deliberately set to display adverts as a means of finding a product or merely as entertainment. Alternatively again, the user of the mobile telephone 10, 20 may actively be seeking products by using the mobile telephone 10, 20 in the manner of an on-line sales catalogue. It really does not matter why the mobile telephone 10, 20 should be displaying adverts; for the purpose of the description of the present invention, it is merely sufficient that it does. Also, within the invention, it really does not matter what areas 30 34 36 other than the display area 28 are present or what they actually do. Nor does it really matter what method of control or selection is employed. Once again, it is simply necessary that a degree of control and selection be made available to allow the invention functionality as hereinafter described.

Within the present invention, the display area 28 on the screen 22 is divided into zones. A first zone is the background zone 38, which in this example spreads from side to side of the display area 28. The background zone 38 has a plurality of display slots 40, each of which represents a position whereat an image of an item to be displayed may be located. The display slots 40 may be caused, slowly, to progress from side to side of the display area 28 as indicated by arrow 42.

The display area 28 also comprises a foreground zone 44 whereat an image of an item may be displayed in greater detail. To be displayed in the foreground zone 44, a larger image is shown. The buttons on the mobile telephone 10, 20, or a graphic user interface cursor, or any combination thereof, can be used to rotate the image in the foreground zone 44 as indicated by horizontal arrow 46 or vertical arrow 48.

A background item whose image is being displayed can, in this example, be selected to become the subject of the foreground zone 44 if a control button, on the front of the mobile telephone 10, 20 is employed, when the image of that object lies over a selection point 50. The exact manner in which images of items in the foreground zone 44 and images of items in the background zone 38 are provided and manipulated is described hereinafter.

FIG. 2A shows just one way in which the present invention can be implemented. Only one background zone has been shown for use showing images of items of just one size. The present invention envisages that there can be more than one background zone 38, that the background zones 38 can have differing sizes, and that one background zone 38 can partially obscure another as a further suggestion of a three dimensional effect with one background zone 38 in front of another. The differing sizes of objects between the background zone 38 and the foreground zone 34 creates a three-dimensional impression as the objects appear to approach the viewer as their size increases. FIG. 2A has shown only three display slots. The present invention envisages that the display slots 40 can number more or less than FIG. 2A shows, and that the display slots 40 can be disposed other than in a straight line. The present invention also envisages that the display slots 40 can add visual variety by the images they support being of non-uniform size, being at apparently different distances from the front of the screen 22. The display slots 40 have been shown moving in a straight line by arrow 42. The present invention also envisages that the display slots 40 can move in trajectories other than straight lines, the only criterion that needs to be observed being that an image of an item to be displayed can enter the display area 28 and some time later can leave the display area 28 unless selected as an occupant for the foreground zone 44.

Attention is next drawn to FIG. 2B, showing a typical display screen 22 as an advertising session progresses. In the background zone 38, in the entering display slot 40A, a single shot camera is seen to be entering the display area 28. The second display slot 40B, near the centre of the display area 28, is displaying a memory stick for a digital camera. A descriptive card 52, in this example, provides text giving technical and price details of the item in the second display slot 40B. The third display slot 40C shows an image of a television set exiting the display area 28. At this point the user has not selected any item to occupy the foreground zone 44.

Attention is drawn to FIG. 3, showing the situation where the user has selected an item to occupy the foreground zone 44. Images of other items are still visible in the background zone 38 in their respective display slots 40A, 40C. A selected item 54 has been moved from the background zone 38 into the foreground zone 44 by being selected by the user. The selected item 54, moving from the background zone 38 into the foreground zone 44 increases in size. In addition, a different view of the selected item 54 may be shown from that of the selected item 54 which was employed in the background zone 38. Further, the foreground view of the selected item 54 overlays and obliterates portions of any item in the same area in the background zone 38. A reasonable facsimile of moving from back to front in three dimensions by the selected item 54 is thus achieved.

Attention is next drawn to FIG. 4, showing an angularly manipulated view of the selected item 54. Wishing more details, the user employs the graphic user interface and/or the buttons on the mobile telephone 10, 20 to rotate the image of the selected item 54 in the foreground zone 44. The image of the selected item 54 dutifully rotates in a vertical or horizontal direction as required. As will later be explained, this is achieved by having either a simple manipulable model of the selected item 54 for display purposes, or having more than one image of the selected item 54. Items in the background zone 38 may or may not be displayed when a selected object 54 is examined in the foreground zone 44.

Attention is next drawn to FIG. 5, which is a flowchart of the activities of a mobile telephone 10, 20 when behaving according to the present invention.

From entry 56 a first test 58 looks to see if there is any reason to display the adverts on the cellular telephone 10, 20. This can be for any of the reasons previously stated. If there is no need to run the adverts, a first operation 60 has the mobile telephone 10, 20 executing any other task which may be required. If the first test 58 detects that it would be appropriate to run the adverts, a second operation 62 recalls the last subject of interest, that is to say, what was last being viewed on the previous occasion when the adverts were being shown. A third operation 64 then constructs the display stage and places images of items thereon. The display stage is essentially the display area 28 shown in FIG. 2A. It is a fixed resource, actually unchanging but appearing to change as images of different items are applied thereto. So far as the display stage or display area 28 is concerned, all images are simply things to be either applied and moved to the display slots 40A, 40B, 40C or moved to the foreground zone 44 and manipulated at that spot. It is a piece of display software resident within the mobile telephone 10, 20, compact in nature and never changing. Its appearance of change, however, is quite remarkably versatile.

The third operation 64, having produced the display screen 22 image and hung or applied the last images of items in the display area 28, a fourth operation 66 rolls the display. The display slots 40 move across the display area 28 and the foreground zone 44 is ever ready to take a foreground view of a selected item.

The mobile telephone 10, 20 comprises a memory which is capable of holding a finite number of images of items to be displayed in the background zone 38 of the display area 28. So long as the last image of an item has not been displayed, the screen 22 can continue uninterrupted. However, a second test 68 must continuously check to see if images have been used up. If images of items to be displayed have been used up, a fifth operation 70 has the mobile telephone 10, 20 request that another set of images be provided. The images are derived by transmission from a server 18 or other resource within the terrestrial telephone network 14.

If the second test 68 did not detect that images have been used up, a third test 72 looks to see if the user of the mobile telephone 10, 20 has selected any item to be presented for inspection in the foreground zone 44. If he or she has not, the display continues to roll. If the user has selected an item for display in the foreground zone 44, a sixth operation 74 records the identity of the item which was so selected. A seventh operation 76 then calculates and sets the subject direction. Thus, is the user had been looking at large trucks, and showed interest in an automobile, the subject direction is towards automobiles or smaller trucks. The next image or set of images to be provided to the mobile telephone 10, 20 will thus show motor vehicles of a smaller size than the previously displayed large trucks. If the user then again selects an automobile, the next item selected will be from a mix of items which display more automobiles, and can include accessories and items associated with automobiles. At the other end of the spectrum, a user may be examining cosmetics and show an interest in hair jewellery and accoutrements. The next selected item will then be more closely hair orientated and may also include peripheral and other items associated with hair, such as hair colour or wigs and so on. The actual direction and manner of change of displayed items, the subject direction, is inevitably somewhat subjective. However, the creator of an advertising site can specify which type or mix of images will be next displayed in a manner which, through time, will become familiar to the user.

The seventh operation 76, having set the subject direction, an eighth operation 78 requests, from the server or other source 18, next images in the set subject direction.

Returning to the fifth operation 70, where images are requested when no item has been selected for display in the foreground zone 44, it will now be understood what is meant when images are requested in the current subject direction.

The eighth 78 and the fifth 70 operations pass control to a ninth operation 80 where the mobile telephone 10, 20 receives the next image or set of images to be displayed. A tenth operation 82 then constructs the next set of images. The images are sent in a highly compacted form and have to be regenerated before they can be displayed. This will be explained later. An eleventh operation 84 then stores the next constructed images and passes control back to the fourth operation 66 where the newly acquired images can be incorporated into the rolling display of items.

From any state 86, operation or test otherwise shown in FIG. 5, should the adverts require to cease because of the intrusion of other material such as an incoming phone call or an outgoing phone call, as detected by a fourth test 88, the mobile telephone 10, 20 in a twelfth operation 90 stores the current images and the current subject direction before proceeding to exit 92.

The selection of which images are next to be displayed as indicated by the fifth operation 70 and the eighth operation 78, can be achieved from a list within the mobile telephone 10, 20 which can have been received from the server or other device 18 or, for preference, can be achieved by the server itself making the choice of what to send to the mobile telephone 10, 20.

Attention is drawn to FIG. 6, showing how the mobile telephone 10, 20 constructs images of display items as indicated by the tenth operation 82. From entry 94 a fifth test 96 checks to see if further images are to be received. If not, the routine terminates in exit 98. If the fifth test 96 detects that there are images yet to come, a thirteenth operation 100 gets the next image from the ninth operation 80. A sixth test 102 then checks to determine the nature of the image which has been received and which requires construction. In this example the sixth test 102 checks to see if it is to be a three-dimensional clad wire model or a multi-angled view. A wire frame clad model is an actual three-dimensional construct which can be rotated and viewed from different angles. A wire frame defines the shape of the image while a cladding of texturing covers the wire frame to give the surface appearance and detail. On the other hand, an angled view object is simply a set of flat images taken from different angles. This is a technique much used in video games. Thus, if an item is selected to be displayed in the foreground zone 44, a wire frame model can actually be rotated in an imaginary three-dimensional space to be displayed on the two-dimensional screen. By contrast, should an angled view image be presented in the foreground zone 44, its rotation in fact involves the selection of a different image taken from as near as possible the angle that is required.

Thus, if the sixth test 102 detects that a wire frame model is the image, a fourteenth operation 104 gets and puts together the wire frame. This may be simple point by point or geometric construction, or may involve a division algorithm. A fifteenth operation then obtains the renderings, textures or other skin that is to go on the wire frame. Once again, this can be simple reception of textures or images of textures, or can be a carefully constructed assembly of finishes. A sixteenth operation 108 then covers the wire frame to complete the image. An example of just one method using wire frame images can be found in United Kingdom patent application no GB0200797.9 filed by the same applicants on 15 Jan. 2002, the contents of which are incorporated herein by reference.

If the sixth test 102 has detected that the image received is angled views, a seventeenth operation 110 simply receives the set of angled views. An eighteenth operation 112 then indicates that the image is ready and returns control to the fifth test 96. The nature of the images sent in this example are merely exemplary. In practice, any kind of image capable of three-dimensional display and/or user driven multi-angle examination will suffice. The transmission of images is economical of time and bandwidth. High resolution images are obtained without the need for continuous provision of signals. Inter-activity with the user is also obtained without the need for a feedback path to the provider being provided to the server 18 or other device.

Attention is next drawn to FIG. 7 showing a flowchart illustrating how a mobile telephone 10, 20 can display images opf items when acting according to the present invention.

From entry 114, a nineteenth operation 116 selects the next item, or rather the image of that item, to be displayed in the display area 28. This next item is to replace the item which is currently leaving the display area 28. Since the next item to be displayed will, at least initially, be in the background zone 38, a twentieth operation 118 selects that image or view of the item to be displayed appropriate to the background zone 38. The background zone 38 image is smaller than the image would be, should the object be selected to be displayed in the foreground zone 44. A twenty-first operation 120 then selects the view of the image of the item which is to be displayed in the background zone 38 and, possibly, on first inspection, as an enlarged image in the foreground zone 44. A twenty-second operation 122 then allocates the image of the item to one of the moving display slots 40 in the background zone 38.

If a seventh test 124 does not detect that a displayed image of an item has been selected for display in the foreground zone 44, control passes back to the nineteenth operation 116 for another object to be selected and inserted onto the screen 22 as an unselected object exits the display area 28. If, however, the seventh test 124 detects that an image of an item has been selected for display and possible examination in the display zone 44, a twenty-third operation 126 moves the selected object image to be displayed in the foreground zone 44 where the selected image is larger. As earlier stated, the selected image of an item may show an altered view of an item and the foreground zone 44 display will overlap and obscure any items remaining in the background zone 38.

An eighth test 128 looks to see if the user wishes to rotate or manipulate the image in the foreground zone 44. If not, a ninth test 130 looks to see if the user wishes to continue with the display and manipulation session. If yes, control passes back to the eighth test 128. If the eighth test detects that the user wishes to manipulate (i.e. rotate and inspect), the image being displayed in the foreground zone 44, a twenty-fourth operation 132 shows or selects the appropriate view and passes control to the ninth test 130.

If the ninth test 130 detects that the user no longer wishes to continue with the current foreground zone 44 display and possible manipulation and inspection, control passes to a tenth test 134 which looks to see if the user wishes to buy the item displayed in the foreground zone 44 or has no further interest and wishes to abandon his curiosity. If the user has no further interest in the item whose image is displayed in the foreground zone 44, a twenty-fifth operation 136 returns the object previously in the foreground zone 44 to the background zone 38 and employing the background size of image and selected preferred fixed view. Control then passes to the nineteenth operation 116 where an object is selected to replace any object whose image may be passing out of the display area 28.

If the tenth test 134 detects that the user is interested in buying, or simply learning further information about the item displayed in the foreground zone 44, a twenty-sixth operation 138 executes a buy routine or gather further information routine, neither of which constitutes part of the present invention. That routine over, if the advertisements are still to roll, control is passed back to the twenty-fifth operation 136.

1-33. (canceled)

34. A method for displaying images of an object, said method including:
sending one or more images of the object to a receiver;
displaying a first image of the object on a screen, at said receiver, for possible selection, as a background perspective;
advancing the first image of the object to a foreground perspective on said screen if the image is selected; and
providing, in the receiver, at least one other selectably displayable image of a foreground perspective of the selected object.

35. A method, according to claim 34, wherein said sending one or more images to a receiver includes sending constructable sets of parts of each image to said receiver and constructing each set of parts to form each image.

36. A method, according to claim 35, wherein said constructable set of parts of each image includes:
specification for a wire frame representative of the shape of the object that the image is intended to represent; and
specification for the provision on the wire frame of a textured skin representative of the appearance of the object the image is intended to represent.

37. A method, according to claim 36, wherein said specification for a wire frame representative of the shape of the object that the image is intended to represent includes specification of the points of a starting mesh and means successively to divide the mesh to provide a frame having the shape of the object.

38. A method, according to claim 35, wherein said at least one other selectably displayable image of a foreground view of the object is achievable by viewing the constructed image from a selectable direction.

39. A method, according to claim 34, wherein said at least one other selectably displayable image of a foreground view of the object is achievable by viewing the constructed image from a selectable distance.

40. A method, according to claim 34, wherein said sending one or more images to said receiver includes the provision of a representation of a first photograph of the object.

41. A method, according to claim 40, wherein said providing, in the receiver, at least one other selectably displayable image of a foreground view of the object, includes sending, to the receiver, at least one representation of a second photograph of the object, from a different viewpoint.

42. A method, according to claim 34, wherein said object is one of a plurality of objects, images of each of the plurality of objects being moveable across a background area until selected for foreground display.

43. A method, according to claim 34, wherein said advancing the first image of an object to foreground display includes:
increasing the size of the first image; and
causing the first image to obscure any image which it overlaps and which is still in the background.

44. A method, according to claim 34, wherein said displaying at least one other selectably displayable image of a foreground perspective of the selected object includes:
substituting said second image for said first image;
increasing the size of said second image; and
causing said second image to obscure any image which it overlaps and which is still in the background.

45. A method, according to claim 34, including providing, in said receiver, a fixed program of display which accepts, displays, moves and allows manipulation of images of objects as equivalent entities, irrespective of what that image might be.

46. A method, according to claim 34, including:
monitoring the nature of the goods represented by the objects, selected for foreground display;
detecting the direction of change of the nature of classification of selected goods away from the current preference; and
providing, to the receiver, a next batch of images whose classification is moved, from the current preference, in the detected direction.

47. A system for displaying images of an object, said system comprising:
a receiver;
transmission means, operative to transmit one or more images of the object to said receiver;
means, at said receiver, to display a first image of the object, as a background perspective, on a screen for possible selection;
means to advance the first image of the object to a foreground perspective on said screen if the image is selected; and
means to provide, in said receiver, at least one other selectably displayable image of a foreground perspective of the selected object.

48. A system, according to claim 47, wherein said means to transmit one or more images of the object to said receiver includes means for sending constructable sets of parts of each image to said receiver and means for constructing each set of parts to form each image.

49. A system, according to claim 48, wherein said constructable set of parts of each image includes:
specification for a wire frame representative of the shape of the object that the image is intended to represent; and
specification for the provision on the wire frame of a textured skin representative of the appearance of the object the image is intended to represent.

50. A system, according to claim 49, wherein said specification for a wire frame representative of the shape of the object that the image is intended to represent includes specification of the points of a starting mesh and means successively to divide the mesh to provide a frame having the shape of the object.

51. A system, according to claim 48, including means to display said at least one other selectably displayable image of a foreground view of the object by viewing the constructed image from a selectable direction.

52. A system, according to claim 48, including means to display said at least one other selectably displayable image of a foreground view of the object by viewing the constructed image from a selectable distance.

53. A system, according to claim 47, wherein said means for sending one or more images to said receiver includes means to provide a representation of a first photograph of the object.

54. A system, according to claim 53, wherein said means to provide, in said receiver, at least one other selectably displayable image of a foreground perspective of the selected object, includes means for sending, to the receiver, at least one representation of a second photograph of the object, from a different viewpoint.

55. A system, according to claim 47, wherein said object is one of a plurality of objects, images of each of the plurality of objects being moveable across a background area until selected for foreground display.

56. A system, according to claim 47, wherein said means to advance the first image of the object to a foreground perspective on said screen if the image is selected comprises:
means to increasing the size of the first image; and
means to cause the first image to obscure any image which it overlaps and which is still in the background.

57. A system, according to claim 47, wherein said means to provide, in said receiver, at least one other selectably displayable image of a foreground perspective of the selected object comprises:
means to substitute said second image for said first image;
means to increase the size of said second image; and
means to cause said second image to obscure any image which it overlaps and which is still in the background.

58. A system, according to claim 47, wherein said receiver comprises a fixed program for displaying images, said fixed program being operative to accept, display, move and allow manipulation of all images of objects as equivalent entities, irrespective of what any particular image might be.

59. A system, according to claim 47, including:
monitoring means, operative to monitor the nature of the goods represented by the objects, selected for foreground display;
trend detection means, operative to detect the direction of change of the nature of classification of goods, selected for foreground display, away from the current preference; and
selection means, operative to provide, to the receiver, a next batch of images whose classification is moved, from the current preference, in the detected direction.

60. A system, according to claim 47, wherein said transmission means comprises a mobile telephone system and wherein said receiver comprises a mobile telephone handset or a Personal Digital Assistant.

61. A system, according to claim 47, wherein said transmission means comprises an Internet transmission device and wherein said receiver comprises a receiver of Internet images.

62. A system, according to claim 47, wherein said transmission means comprises a digital transmission device and wherein said receiver comprises a receiver of digitally conveyed images.

63. Reception means, operative to act as said receiver in a system as claimed in claim 47.

64. Reception means, operative to act as said receiver when used in conjunction with a method as claimed in claim 34.

65. Transmission means, for use in transmitting images in a system as claimed in claim 47.

66. Transmission means, for use in sending images in conjunction with a method as claimed in claim 34.

67. A method for displaying images of an object, said method including:
sending one or more images of the object to a receiver;
displaying a first image of the object on a screen, at said receiver, for possible selection, as a background perspective; advancing the first image of the object to a foreground perspective on said screen if the image is selected; and
providing, in the receiver, at least one other selectably displayable image of a foreground perspective of the selected object;
wherein said sending one or more images to a receiver includes sending constructable sets of parts of each image to said receiver and constructing each set of parts to form each image; and
said constructable set of parts of each image includes:
specification for a wire frame representative of the shape of the object that the image is intended to represent; and
specification for the provision on the wire frame of a textured skin representative of the appearance of the object the image is intended to represent.

68. A method for displaying images of an object, said method including:
sending one or more images of the object to a receiver;
displaying a first image of the object on a screen, at said receiver, for possible selection, as a background perspective;
advancing the first image of the object to a foreground perspective on said screen if the image is selected; and
providing, in the receiver, at least one other selectably displayable image of a foreground perspective of the selected object;
wherein said sending one or more images to a receiver includes sending constructable sets of parts of each image to said receiver and constructing each set of parts to form each image, and said constructable set of parts of each image includes:
specification for a wire frame representative of the shape of the object that the image is intended to represent; and
specification for the provision on the wire frame of a textured skin representative of the appearance of the object the image is intended to represent;
said specification for a wire frame representative of the shape of the object that the image is intended to represent including specification of the points of a starting mesh and means successively to divide the mesh to provide a frame having the shape of the object.

69. A method for displaying images of an object, said method including:
sending one or more images of the object to a receiver;
displaying a first image of the object on a screen, at said receiver, for possible selection, as a background perspective;
advancing the first image of the object to a foreground perspective on said screen if the image is selected; and
providing, in the receiver, at least one other selectably displayable image of a foreground perspective of the selected object; and
wherein said sending one or more images to said receiver includes the provision of a representation of a first photograph of the object, and said providing, in the receiver, at least one other selectably displayable image of a foreground view of the object, includes sending, to the receiver, at least one representation of a second photograph of the object, from a different viewpoint.

70. A method for displaying images of an object, said method including:
sending one or more images of the object to a receiver;
displaying a first image of the object on a screen, at said receiver, for possible selection, as a background perspective;
advancing the first image of the object to a foreground perspective on said screen if the image is selected; and
providing, in the receiver, at least one other selectably displayable image of a foreground perspective of the selected object; and
wherein said sending one or more images to said receiver includes the provision of a digital image of the object, and said providing, in the receiver, at least one other selectably displayable image of a foreground view of the object, includes sending, to the receiver, at least a second digital image of the object, from a different viewpoint.

71. A method for displaying images of an object, said method including:
sending one or more image of the object to a receiver;
displaying a first image of the object on a screen, at said receiver, for possible selection, as a background perspective;
advancing the first image of the object to a foreground perspective on said screen if the image is selected; and
providing, in the receiver, at least one other selectably displayable image of a foreground perspective of the selected object;
wherein said sending one or more images to a receiver includes sending constructable sets of parts of each image to said receiver and constructing each set of parts to form each image, and said constructable set of parts of each image includes:
specification for a wire frame representative of the shape of the object that the image is intended to represent; and
specification for the provision on the wire frame of a textured skin representative of the appearance of the object the image is intended to represent;
said receiver comprising a mobile telecommunications device.

72. A method for displaying images of an object, said method including:
sending one or more images of the object to a receiver;
displaying a first image of the object on a screen, at said receiver, for possible selection, as a background perspective;
advancing the first image of the object to a foreground perspective on said screen if the image is selected; and
providing, in the receiver, at least one other selectably displayable image of a foreground perspective of the selected object;
wherein said sending one or more images to a receiver includes sending constructable sets of parts of each image to said receiver and constructing each set of parts to form each image, and said constructable set of parts of each image includes:
specification for a wire frame representative of the shape of the object that the image is intended to represent; and
specification for the provision on the wire frame of a textured skin representative of the appearance of the object the image is intended to represent;
said specification for a wire frame representative of the shape of the object that the image is intended to represent including specification of the points of a starting mesh and means successively to divide the mesh to provide a frame having the shape of the object; and
said receiver comprising a mobile telecommunications device.

73. A method for displaying images of an object, said method including:
sending one or more images of the object to a receiver;
displaying a first image of the object on a screen, at said receiver, for possible selection, as a background perspective;
advancing the first image of the object to a foreground perspective on said screen if the image is selected; and
providing, in the receiver, at least one other selectably displayable image of a foreground perspective of the selected object;
wherein said sending one or more images to said receiver includes the provision of a representation of a first photograph of the object, and said providing, in the receiver, at least one other selectably displayable image of a foreground view of the object, includes sending, to the receiver, at least one representation of a second photograph of the object, from a different viewpoint;
said receiver comprising a mobile telecommunications device.

74. A method for displaying images of an object, said method including:
sending one or more images of the object to a receiver;
displaying a first image of the object on a screen, at said receiver, for possible selection, as a background perspective;
advancing the first image of the object to a foreground perspective on said screen if the image is selected; and
providing, in the receiver, at least one other selectably displayable image of a foreground perspective of the selected object;
wherein said sending one or more images to said receiver includes the provision of a digital image of the object, and said providing, in the receiver, at least one other selectably displayable image of a foreground view of the object, includes sending, to the receiver, at least a second digital image of the object, from a different viewpoint;
said receiver comprising a mobile telecommunications device.

75. A system for displaying images of an object, said system comprising:
a receiver;
transmission means, operative to transmit one or more images of the object to said receiver;
means, at said receiver, to display a first image of the object, as a background perspective, on a screen for possible selection;
means to advance the first image of the object to a foreground perspective on said screen if the image is selected; and
means to provide, in said receiver, at least one other selectably displayable image of a foreground perspective of the selected object;
wherein said means to transmit one or more images of the object to said receiver includes means for sending constructable sets of parts of each image to said receiver and means for constructing each set of parts to form each image, and said constructable set of parts of each image includes:
specification for a wire frame representative of the shape of the object that the image is intended to represent; and
specification for the provision on the wire frame of a textured skin representative of the appearance of the object the image is intended to represent;
said specification for a wire frame representative of the shape of the object that the image is intended to represent including specification of the points of a starting mesh and means successively to divide the mesh to provide a frame having the shape of the object.

76. A system for displaying images of an object, said system comprising:
receiver;
transmission means, operative to transmit one or more images of the object to said receiver;
means, at said receiver, to display a first image of the object, as a background perspective, on a screen for possible selection;
means to advance the first image of the object to a foreground perspective on said screen if the image is selected;
means to provide, in said receiver, at least one other selectably displayable image of a foreground perspective of the selected object; and
wherein said means for sending one or more images to said receiver includes means to provide a representation of a first photograph of the object, and said means to provide, in said receiver, at least one other selectably displayable image of a foreground perspective of the selected object, includes means for sending, to the receiver, at least one representation of a second photograph of the object, from a different viewpoint.

77. A system for displaying images of an object, said system comprising:
a receiver;
transmission means, operative to transmit one or more images of the object to said receiver;
means, at said receiver, to display a first image of the object, as a background perspective, on a screen for possible selection;
means to advance the first image of the object to a foreground perspective on said screen if the image is selected; and means to provide, in said receiver, at least one other selectably displayable image of a foreground perspective of the selected object;
wherein said means to transmit one or more images of the object to said receiver includes means for sending constructable sets of parts of each image to said receiver and means for constructing each set of parts to form each image, and said constructable set of parts of each image includes:
specification for a wire frame representative of the shape of the object that the image is intended to represent; and
specification for the provision on the wire frame of a textured skin representative of the appearance of the object the image is intended to represent;
said specification for a wire frame representative of the shape of the object that the image is intended to represent including specification of the points of a starting mesh and means successively to divide the mesh to provide a frame having the shape of the object; and
said transmission means comprising a mobile telecommunications device system and said receiver comprising a mobile telecommunications device.

78. A system for displaying images of an object, said system comprising:
a receiver;
transmission means, operative to transmit one or more images of the object to said receiver;
means, at said receiver, to display a first image of the object, as a background perspective, on a screen for possible selection;
means to advance the first image of the object to a foreground perspective on said screen if the image is selected; and
means to provide, in said receiver, at least one other selectably displayable image of a foreground perspective of the selected object;
wherein said means for sending one or more images to said receiver includes means to provide a representation of a first photograph of the object, and said means to provide, in said receiver, at least one other selectably displayable image of a foreground perspective of the selected object, includes means for sending, to the receiver, at least one representation of a second photograph of the object, from a different viewpoint;
said transmission means comprising a mobile telecommunications device system and said receiver comprising a mobile telecommunications device.

79. A system for displaying images of an object, said system comprising:
a receiver;
a transmission system, operative to transmit one or more images of the object to said receiver;
a display module, at said receiver, to display a first image of the object, as a background perspective, on a screen for possible selection;
a controller arranged to advance the first image of the object to a foreground perspective on said screen if the image is selected; and
an image provider arranged to provide, in said receiver, at least one other selectably displayable image of a foreground perspective of the selected object.

80. A method for displaying images of an object, said method including:
sending one or more images of the object to a receiver;
displaying a first image of the object on a screen, at said receiver, for possible selection, as a background perspective;
advancing the first image of the object to a foreground perspective on said screen if the image is selected;
providing, in the receiver, at least one other selectably displayable image of a foreground perspective of the selected object; and
wherein said receiver comprises a mobile telecommunications device.

81. A system for displaying images of an object, said system comprising:
a receiver;
transmission means, operative to transmit one or more images of the object to said receiver;
means, at said receiver, to display a first image of the object, as a background perspective, on a screen for possible selection;
means to advance the first image of the object to a foreground perspective on said screen if the image is selected;
means to provide, in said receiver, at least one other selectably displayable image of a foreground perspective of the selected object; and
wherein said transmission means comprises a mobile telecommunications device system and said receiver comprises a mobile telecommunications device.
